(19) United States
(12) Patent Application Publication
(10) Pub. No.: US 2025/0278911 A1
(43) Pub. Date: Sep. 4, 2025

(54) Method and Device for Operating a Display System Comprising Smartglasses in a Vehicle for Latency-Free Contact-Analogous Display of Vehicle-Fixed and World-Fixed Display Objects

(71) Applicant: Bayerische Motoren Werke Aktiengesellschaft, Muenchen (DE)

(72) Inventors: Tobias BAUERNFEIND, Muenchen (DE); Wolfgang HABERL, Muenchen (DE); Alan KEIM, Hallbergmoos (DE); Manfred PAULI, Bruckberg (DE)

(21) Appl. No.: 19/059,618

(22) Filed: Feb. 21, 2025

(30) Foreign Application Priority Data
Mar. 1, 2024 (DE) 10 2024 105 934.6

(51) Int. Cl. G06T 19/20; G02B 27/01; G06F 3/01; G06T 3/18

(52) U.S. Cl. CPC G06T 19/20; G02B 27/017; G06F 3/013; G06T 3/18; G02B 2027/0178; G06T 2219/2016

(57) ABSTRACT

A method for operating a display system including smartglasses in a vehicle that has a glasses-external central processing unit is disclosed. The method includes providing object information in the central processing unit; providing a surroundings-based glasses pose in a surroundings coordinate system and/or a vehicle-based glasses pose in a vehicle coordinate system; rendering a display object for the respective object information for contact-analogous vehicle-fixed or world-fixed display according to the glasses pose; transferring the display object to the smartglasses via a communication connection; acquiring a piece of glasses motion information via a glasses inertial sensor system and/or a piece of vehicle motion information via a vehicle inertial sensor system; performing a warping process for the display object based on a change in the world-fixed glasses pose during a latency period and/or based on a change in the world-fixed vehicle pose during the latency period, and displaying the warped display object.

### CROSS REFERENCE TO RELATED APPLICATION

This application claims priority under 35 U.S.C. § 119 from German Patent Application No. 10 2024 105 934.6, filed Mar. 1, 2024, the entire disclosure of which is herein expressly incorporated by reference.

### BACKGROUND AND SUMMARY

The invention relates to display systems comprising smartglasses for use in a vehicle. The invention furthermore relates to measures for operating smartglasses for viewing-direction-dependent, i.e., contact-analogous, display of display objects.

Smartglasses, also called head-mounted displays, which can use a display device to display an image representation of display objects on one or two display surfaces in the field of view of the wearer of the smartglasses, are known. The display surfaces may correspond to reflection surfaces that direct image representations into the eye of the wearer of the smartglasses. The display surfaces are located in viewing openings in the smartglasses and are transparent, and so the display surfaces of the smartglasses also allow the real surroundings to be perceived in the usual way. The display surfaces can be used to display displayable information in the form of display objects, such as text, symbols, graphics, video displays and the like, in a manner overlaid on the perception of the surroundings.

The display objects can generally be represented in a contact-analogous manner for the wearer of the smartglasses, i.e., represented such that they are overlaid on, or oriented to, a specific associated object in the real surroundings as object information or that the displayable object information is displayed in a specific orientation of the smartglasses, or the wearer thereof. Furthermore, the contact-analogous display objects can be represented as three-dimensional objects such that they appear in the correct perspective in relation to the real surroundings and the pose of the wearer of the smartglasses, i.e., the illusion arises that the real surroundings have actually been supplemented by the additional feature of the visual display object.

To display the display objects on the display surfaces of the smartglasses in an accordingly contact-analogous manner, however, it is necessary to know the position of the object in the surroundings and the viewing direction of the user. The viewing direction of the user, when they are wearing the smartglasses, is firmly associated with the pose of the smartglasses, i.e., the 3D position and the 3D orientation of the smartglasses based on six degrees of freedom (6 DoF).

The glasses pose of smartglasses can also be ascertained by an external pose detection unit, which involves a vehicle-mounted interior camera in the vehicle capturing the head of the wearer of the smartglasses and evaluation of the camera image being used either to determine the pose of the head and to derive the pose of the smartglasses therefrom or to determine the pose of the smartglasses directly. With these so-called outside-in tracking systems, it is difficult to transfer the pose information relating to the vehicle-based glasses pose, which is determined outside the smartglasses, to the smartglasses with sufficiently low latency, especially given a wireless communication connection, so that the smartglasses can accordingly output contact-analogous representations of display objects without delay, or with only a non-distracting delay.

Contact-analogous display objects can be displayed in the smartglasses in a vehicle-fixed manner, i.e., with reference to a vehicle coordinate system, or in a world-fixed manner, i.e., with reference to a surroundings coordinate system. Vehicle-fixed contact-analogous display objects are oriented to a stipulated position in the vehicle and require a vehicle-based glasses pose to be correctly displayed in the smartglasses, while world-fixed contact-analogous display objects are oriented to a surroundings-based glasses pose that is independent of the vehicle-based glasses pose.

For latency-free display of display objects, supplied object information in the smartglasses is frequently taken as a basis for rendering the display image at a low frequency at rendering times and, between the rendering times, using higher-frequency transformation, so-called warping, to (repeatedly) shift the rendered display image in the image plane of the display surface of the smartglasses in two dimensions in order to correct the representation of display objects with respect to an interim change in the glasses pose. Although shifting the image in two dimensions for the warping method does not permit perspective correction, perspective errors during the short intervals of time between the rendering times are generally not perceptible to a wearer of the smartglasses. The warping method can thus be used to undertake fast, low-latency correction of the display position of a display object on the display surface of the smartglasses.

Such a warping method is described, for example under the name “temporal reprojection” or “asynchronous time warping”, in Aga, H., Ishihara, A., Kawasaki, K., Nishibe, M., Kohara, S., Ohara, T. and Fukuchi, M. (2019), 24-2: Latency Compensation for Optical See-Through Head-Mounted with Scanned Display. SID Symposium Digest of Technical Papers, 50: 330-333.

Today, smartglasses for augmented reality representations generally have a slim design. Hence, such smartglasses, which are wirelessly connected to an external unit, are designed to have low-capacity batteries and energy-saving microprocessors. As a result, resource-intensive operations cannot be carried out in the smartglasses.

During conventional operation of smartglasses, contact-analogous display of a display object is achieved by transmitting appropriate low-complexity object information to the smartglasses, which is rendered there to produce a display object that can be represented three-dimensionally or in perspective. For real-time-capable display, this object information can only represent a few hundred thousand vertices in a displayable display image in real time.

It is not possible to represent high-resolution display objects in this way. The rendering process is also very computationally complex, and so, as the number of vertices increases, although the display objects can still be displayed in real time, they cause an energy consumption that significantly limits the running time of the smartglasses with one battery charge.

It is therefore an object of the present invention to provide an improved option that allows the running time of battery-operated smartglasses to be extended and the complexity of the representation of display objects to be increased.

According to a first aspect, there is provision for a method for operating a display system comprising smartglasses in a vehicle comprising a glasses-external central processing unit, having the following steps:
providing at least one piece of object information in the central processing unit;
providing a surroundings-based glasses pose with respect to a surroundings coordinate system and/or a vehicle-based glasses pose with respect to a vehicle coordinate system in the central processing unit;
rendering at least one display object for the respective at least one piece of object information for contact-analogous vehicle-fixed or world-fixed display according to the surroundings-based or the vehicle-based glasses pose in the central processing unit;
transferring the at least one display object to the smartglasses via a communication connection;
acquiring a piece of glasses motion information by means of a glasses inertial sensor system and/or a piece of vehicle motion information by means of a vehicle inertial sensor system,
performing a warping process for the at least one display object based on a change in the world-fixed glasses pose during a latency period and/or based on a change in the world-fixed vehicle pose during the latency period,
displaying the at least one warped display object.

Furthermore, the surroundings-based glasses pose can be determined in the smartglasses based on the glasses motion information, the vehicle-based glasses pose being determined on the basis of the surroundings-based glasses pose and vehicle motion information.

The basic idea of the above method is that the rendering of the display object, i.e., the rendered object information (e.g., vector graphic information or vector model of a 3D object), is relocated to a glasses-external central processing unit, for example, to the driver assistance system of a vehicle. The term “rendering” refers to the process of creating display images or display objects from models that are provided in the form of object information. Rendering is equivalent to converting design data into a visual format. Thus, images of complex display objects, for example complex 3D scenes, can be rendered in the central processing unit from object information to then transmit the rendered display image to the smartglasses via the communication connection.

The rendering is effected on the basis of a 6 DoF pose of the smartglasses, which can be provided either by a pose detection system in the vehicle (inside-out tracking) or by the smartglasses via the communication connection or by sensor fusion of a glasses pose determined by a pose detection system in the vehicle and a glasses pose provided by the smartglasses via the communication connection. The 6 DoF pose indicates the perspective relation of the displayable object with reference to the viewing direction of the user. The image of the display object to be transmitted then corresponds only to a 2D representation, which can be displayed in the smartglasses without additional rendering.

While the rendering in the smartglasses conventionally involves latency compensation already being effected in the rendering process as a result of prediction of the change in the pose of the smartglasses, the above method involves warping of the display object in the smartglasses additionally being undertaken for the representation and the latency compensation of the 2D image of the display object. The warping corresponds to simple latency compensation as a result of translationally shifting the 2D image of the display object on the display surface of the smartglasses or as a result of scaling, i.e., changing the size of the 2D object information according to the change in the glasses pose that occurred during the latency period.

The 3D object information to be represented is generally present in the central processing unit or in the vehicle assistance system and can be a high-resolution 3D model in the form of a vector graphic or a 3D map material from a map service and the like. Due to the generally significantly higher performance of a data processing device in a central processing unit or in the vehicle assistance system, it is possible for an extensive rendering process for 3D object information to be undertaken there, based on a glasses pose of the smartglasses. The glasses pose of the smartglasses can be provided either by a pose detection device of the central processing unit/the vehicle assistance system or by way of the smartglasses via a communication connection or by way of appropriate sensor fusion.

If the glasses pose is transferred by the smartglasses, latency compensation for the transmission latency of the communication connection can be undertaken in the central processing unit or in the vehicle assistance system.

Furthermore, since the glasses pose is generally provided in the smartglasses in a world-fixed coordinate system, acquisition of motion information relating to the vehicle in the surroundings allows the central processing unit to determine a vehicle-fixed glasses pose. Thus, 3D object information can be rendered with reference to both a vehicle-fixed and a world-fixed glasses pose and transmitted to the smartglasses accordingly. It is also possible for multiple pieces of object information to be rendered using different reference systems for the glasses pose.

The at least one rendered display object is transferred to the smartglasses after rendering. A warping process is carried out on the at least one display object in the smartglasses. The warping process can then be corrected with respect to the world-fixed coordinate system, i.e., the surroundings coordinate system, or with respect to the vehicle coordinate system as appropriate with reference to a movement of the smartglasses during the latency period for the transmission of the 2D image. In the case of warping with reference to a vehicle coordinate system, motion information relating to the vehicle can be transferred with the at least one display object, said motion information permitting a prediction of the change in the vehicle-fixed glasses pose during the latency period for the generation of the display object.

There may be provision for the warping process in the smartglasses and the display of the at least one warped display object to be performed at a higher frequency than the rendering.

According to another aspect, there is provision for a display system comprising a central processing unit in a vehicle and smartglasses, the central processing unit comprising:
a communication unit;
a control unit, which is designed to carry out the following steps:
   providing at least one piece of object information;
   providing a surroundings-based glasses pose with respect to a surroundings coordinate system and/or a vehicle-based glasses pose with respect to a vehicle coordinate system;
   rendering at least one display object for the respective at least one piece of object information for contact-analogous vehicle-fixed or world-fixed display according to the surroundings-based or the vehicle-based glasses pose in the central processing unit;
   transferring the at least one display object to the smartglasses via the communication connection;
smartglasses, which are designed to carry out the following steps:
   acquiring glasses motion information by means of a glasses inertial sensor system and/or obtaining vehicle motion information,
   performing a warping process for the at least one display object based on a change in the world-fixed glasses pose during a latency period and/or based on a change in the world-fixed vehicle pose during the latency period,
   displaying the at least one warped display object.

Embodiments are explained in more detail below with reference to the accompanying drawings, in which:

### BRIEF DESCRIPTION OF THE DRAWINGS

FIG. 1 shows a schematic representation of a display system in a vehicle comprising smartglasses and a central processing unit;

FIG. 2 shows a flowchart to illustrate a method for operating the display system for contact-analogous representation of surroundings-position-based and vehicle-position-based display objects.

### DETAILED DESCRIPTION OF THE DRAWINGS

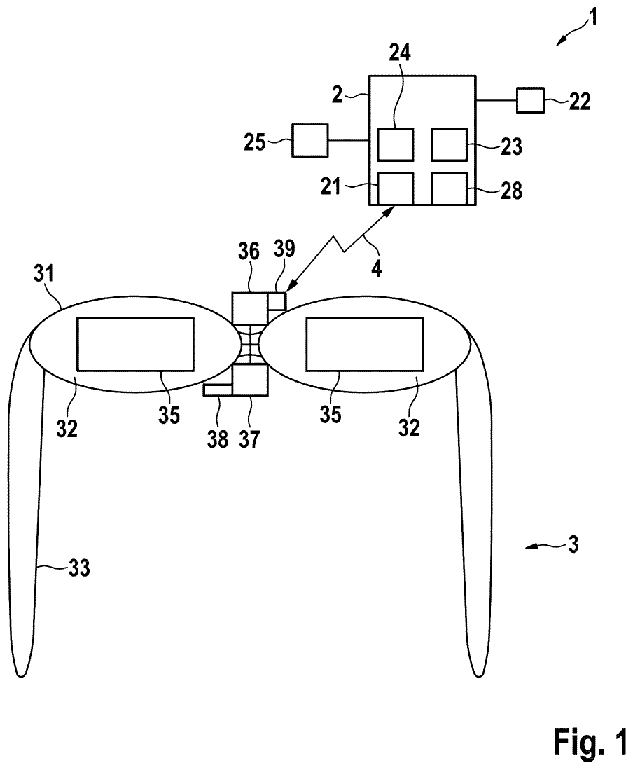

FIG. 1 shows a schematic representation of a display system 1 for use in a vehicle. The display system 1 comprises a central processing unit 2, which has a communication connection 4 to smartglasses 3. The communication connection 4 is in the form of a data transmission channel, e.g., in the form of a wireless communication connection or a wired communication connection. The communication connection 4 is able to transfer any kind of data and information between the assistance system 2 and the smartglasses 3, for example, on the basis of a packet-mode data transmission. By way of example, the communication connection 4 may be based on WiFi, Bluetooth, Bluetooth Low Energy or a comparable standardized radio protocol.

The central processing unit 2 may be part of a vehicle assistance system and provided at a fixed location in the vehicle. The central processing unit 2 may be equipped with a communication unit 21 that permits the communication connection 4 between the smartglasses 3 and the assistance system 2.

The central processing unit 2 may furthermore be connected to a surroundings capture system 22, which has one or more cameras. The surroundings capture system 22 can capture a surroundings image representation of the surroundings of the vehicle. The one or more cameras can comprise, e.g., an RGB camera, an IR camera, a fisheye camera, a dynamic vision sensor and the like. The surroundings capture system 22 may be part of a localization system that can use matching with high-precision map data to ascertain a geo-position of the vehicle, i.e., a vehicle pose, including a position and an orientation of the vehicle in a world-fixed coordinate system (surroundings coordinate system).

The central processing unit 2 may alternatively or additionally have a positioning device 28. The positioning device 28 can comprise a GPS system for detecting a geo-position of the vehicle and/or an odometry unit for providing details of motion information (speed, steering angle) relating to the vehicle with respect to the surroundings. Additionally (as a result of fusion of the position information) or alternatively, a geo-position of the vehicle can be ascertained by means of the surroundings image representation captured by the surroundings capture system 22 and matching with high-precision map data. The geo-position and orientation of the vehicle correspond to a vehicle pose in the surroundings coordinate system.

The central processing unit 2 can have a control unit 23 that, according to a geographical position of the vehicle and according to a surroundings image representation captured by the surroundings capture system 22, generates and/or ascertains at least one piece of surroundings-based or surroundings-fixed object information (street name, direction arrow, etc.) in a manner known per se for display in the smartglasses 3. The surroundings position of the at least one virtual surroundings-based display object is specified with respect to a stipulated, predefined surroundings coordinate system. Alternatively or additionally, one or more pieces of object information can be provided in the central processing unit 2 that are intended for representation with reference to a vehicle-fixed coordinate system (vehicle coordinate system), e.g., expansible instrument displays or the like (vehicle-fixed object information).

There may be provision for an interior camera 25 directed to a target position (eyebox) for the smartglasses 3. The central processing unit 2 can use inherently known methods of object or pattern recognition to track the smartglasses 3 with reference to the vehicle coordinate system, to obtain a vehicle-based glasses pose of the smartglasses 3 in the vehicle coordinate system in the central processing unit 2.

The central processing unit 2 can furthermore comprise a vehicle inertial sensor system 24 that detects the movement of the vehicle in the form of vehicle acceleration information with reference to the surroundings coordinate system. The vehicle acceleration information can be converted into relative changes in the vehicle pose by way of double integration with respect to time.

The control unit 23 may be intended to render at least one piece of object information, which is provided in the central processing unit 2, with reference to a vehicle-fixed or world-fixed glasses pose. The rendering is achieved by means of known rendering methods and is used to generate a display object in the correct perspective as the displayable image according to the glasses pose and the position and orientation of the object from the object information. A vehicle-fixed glasses pose is utilized when the object information is vehicle-fixed, i.e., specified with reference to a vehicle coordinate system, and a world-fixed glasses pose is utilized when the object information is world-fixed, i.e., specified with reference to a surroundings coordinate system. The rendered display object is then transmitted to the smartglasses 3.

The smartglasses 3 comprise two transparent lenses 32 that are enclosed in a frame 31 in a manner known per se. The frame 31 is designed, by way of example, to have glasses temples 33, so that the smartglasses 3 can be worn on the head of a user in a manner known per se.

One or both lenses 32 (glasses lenses) are furthermore provided with a transparent display surface 35, through which a display image for representing virtual display objects can be projected into the eye of the wearer of the smartglasses 3 by a suitable device, for example, a display device 36 arranged on the frame 31. The display device 36 may have a microprocessor or a comparable computing unit and a display unit, e.g., a projection device or the like. The display unit may be designed to direct the electronically generated display image onto the display surface 35 and to image/present it there.

Owing to the transparent design of the display surface 35, the electronically generated display image can overlie the real surroundings perceptible by way of the display surface 35. The display device 36 can be used to represent a virtual display object, such as a text, a symbol, video information, a graphic or the like, on one or both display surfaces 35.

The smartglasses 3 may be worn on the head of the user like a typical visual aid, wherein the smartglasses 3 may rest on the nose of the user by way of the frame 31 and the temples 33 may lie laterally against the head of the user. The viewing direction of the user straight ahead then results from the transparent display surfaces 35 of the lenses 32, such that the viewing direction of the user, which is predetermined by an eye position and an optical visual axis (eye axis), has a fixed reference with respect to the orientation of the smartglasses 3. This reference is individually dependent on the wearer of the smartglasses 3 and is indicated by calibration information.

For the display of surroundings-based and/or vehicle-based display objects on the display surface, corresponding object information can be provided as vector data in the central processing unit 2. The object information specifies the type of display object to be represented, e.g., a text object, an icon, an image object, a video object or another identification of a display area in unrendered form. Furthermore, the object information indicates a vehicle-fixed position of the displayable display object in the vehicle coordinate system (as a vehicle-position-based display object) or a world-fixed position of the displayable display object in the surroundings coordinate system (as a surroundings-position-based display object).

There may be provision for a glasses inertial sensor system 38, e.g., in the form of a 6 DoF inertial sensor. This provides glasses motion information in the form of translational accelerations and (rotational) angular accelerations and, if necessary, also angular velocities of the rotational movements with reference to the (world-fixed) surroundings, which information can be converted into a change of position and orientation with reference to the (world-fixed) surroundings, i.e., a relative glasses pose, within a period by way of the respective double integration with respect to time.

A control unit 37 can be used to receive display objects rendered in the central processing unit and optionally object information to be rendered in the smartglasses from the central processing unit 2 via a communication device 39. Received object information is intended for rendering in the smartglasses 3 and is processed so that it can be displayed in a contact-analogous manner in the respective viewing angle range in which the user of the smartglasses 3 looks (determined by the glasses pose). Specifically, the display object indicated by the object information is displayed on the display surface 35 if its surroundings-based or vehicle-based virtual position is in the viewing angle range.

Part or all of the function of the control unit 37 and/or the communication unit 39 may be accommodated on a companion device that is physically separate from the smartglasses 3 (e.g., a smartphone), which in turn can be connected to the actual smartglasses 3 wirelessly or by a cable.

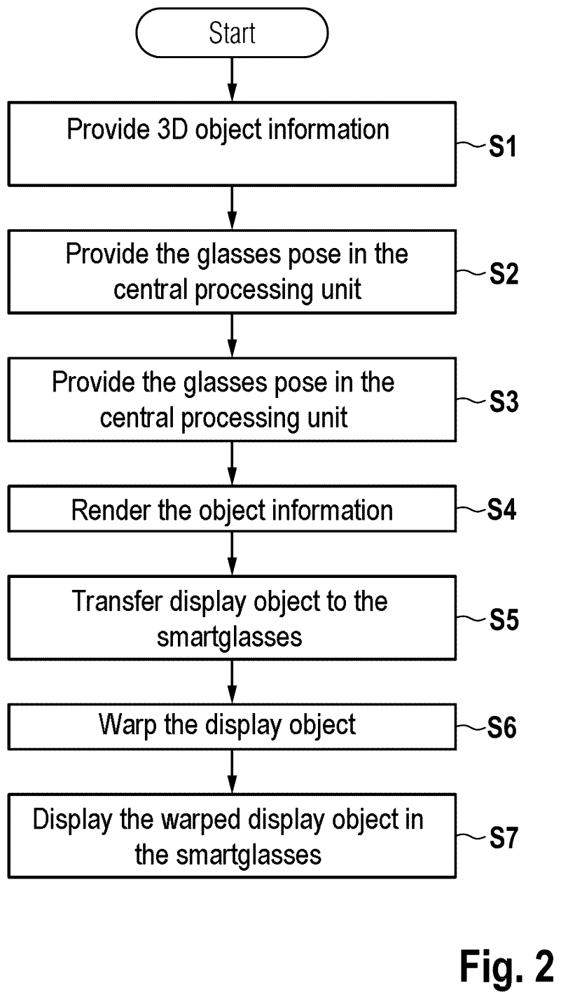

FIG. 2 shows a flowchart to illustrate a method for representing rendered 3D display objects in the smartglasses 3. For this purpose, object information is preferably provided for a 3D display object in the central processing unit, e.g., the vehicle assistance system. The 3D object information can be provided by a navigation system or by another function of the central processing unit 2 and corresponds to a 3D object that is located at a specific position with reference to a vehicle coordinate system or with reference to a surroundings coordinate system.

In step S2, a glasses pose is provided in the central processing unit 2. The glasses pose can be provided with reference to a vehicle coordinate system and/or a surroundings coordinate system, depending on whether the object information describes a display object that is supposed to be displayed in a vehicle-fixed or world-fixed contact-analogous manner.

The glasses pose can always be provided in the smartglasses 3 in real time based on glasses motion information and in step S3 can be transferred from the smartglasses 3 to the central processing unit 2 via the communication connection 4. The world-fixed glasses pose can be determined by way of integration in the smartglasses 3 based on the glasses motion information and is calibrated either in the vehicle-fixed coordinate system or in the world-fixed coordinate system at predetermined times, e.g., by way of an absolute glasses pose determined by the central processing unit 2. Alternatively, suitable inherently known optical pose acquisition devices can be used in the central processing unit 2 to determine the vehicle-fixed or world-fixed glasses pose of the smartglasses 3.

The supplied 3D object information is now rendered in the central processing unit 2 in step S4 according to the glasses pose by means of a suitable rendering method, to provide a display object in the form of a 2D image for display in the smartglasses 3 from the 3D object information. The 2D image corresponds to the display object that the wearer of the smartglasses 3 is supposed to see on the display surface in the glasses pose under consideration. Depending on the type of object information, i.e., the indication of the position of the displayable display object in the vehicle coordinate system or surroundings coordinate system, the object information is rendered with reference to a vehicle-fixed or world-fixed glasses pose to obtain a vehicle-fixed or world-fixed display object.

In step S5, the 2D image of the display object is transferred to the smartglasses 3 via the communication connection 4.

In step S6, a so-called inherently known warping method is used in the smartglasses 3 to compensate for the transmission latency, which is supposed to correspond to the period from the beginning of the rendering of the object information to the time of reception in the smartglasses 3, or to the time of display on the display surfaces of the smartglasses 3. Specifically, an interim change in the pose of the smartglasses 3 is detected by way of the glasses motion information in the smartglasses 3 and a warping method is carried out that translationally shifts, rotates and/or scales the image during the latency period according to the change in the glasses pose. It is thus possible to compensate for rotational and tilting movements of the head, inclining movements of the head and translational forward and backward movements of the head during the latency period until the 2D image is ready for display in the smartglasses.

In step S7, the warped display object is displayed in the smartglasses 3 and the method is repeated cyclically by returning to step S1.

Since the combination of 3D rendering in the data processing device of the central processing unit 2 and the warping method in the smartglasses 3 is carried out, it is thus possible to render and represent very complex 3D object information without overloading or exhausting the processing capacities of the smartglasses. The warping method is generally a very simple computation process that can also be carried out on complex 2D images in real time without much effort.

### LIST OF REFERENCE SIGNS

1 Display system
2 Central processing unit
3 Smartglasses
4 Communication connection
21 Communication unit
22 Surroundings capture system
23 Control unit
24 Vehicle inertial sensor system
25 Interior camera
28 Positioning device
31 Frame
32 Lenses
33 Glasses temples
35 Display surface
36 Display device
37 Control unit
38 Glasses inertial sensor system
39 Communication device.

What is claimed is:

1. A method for operating a display system including smartglasses in a vehicle including a glasses-external central processing unit, the method comprising:
providing at least one piece of object information in the central processing unit;
providing a surroundings-based glasses pose with respect to a surroundings coordinate system and/or a vehicle-based glasses pose with respect to a vehicle coordinate system in the central processing unit;
rendering at least one display object for the respective at least one piece of object information for contact-analogous vehicle-fixed or world-fixed display according to the surroundings-based or the vehicle-based glasses pose in the central processing unit;
transferring the at least one display object to the smartglasses via a communication connection;
acquiring glasses motion information via a glasses inertial sensor system and/or vehicle motion information via a vehicle inertial sensor system;
performing a warping process in the smartglasses for the at least one display object based on a change in the world-fixed glasses pose during a latency period and/or based on a change in the world-fixed vehicle pose during the latency period;
displaying the at least one warped display object in the smartglasses.

2. The method according to claim 1, wherein the surroundings-based glasses pose is determined in the smartglasses based on the glasses motion information, the vehicle-based glasses pose being determined based on the surroundings-based glasses pose and vehicle motion information.

3. The method according to claim 1, wherein the warping process for each of the display objects is performed with reference to a change in the world-fixed glasses pose or vehicle-fixed glasses pose during the latency period by virtue of the image of the at least one display object being translationally shifted, rotated and/or scaled according to the change in the world-fixed or vehicle-fixed glasses pose.

4. The method according to claim 2, wherein the warping process for each of the display objects is performed with reference to a change in the world-fixed glasses pose or vehicle-fixed glasses pose during the latency period by virtue of the image of the at least one display object being translationally shifted, rotated and/or scaled according to the change in the world-fixed or vehicle-fixed glasses pose.

5. The method according to claim 1, wherein the latency period corresponds to the period from a time of a beginning of rendering to a time of display of the image of the at least one display object in the smartglasses.

6. The method according to claim 2, wherein the latency period corresponds to the period from a time of a beginning of rendering to a time of display of the image of the at least one display object in the smartglasses.

7. The method according to claim 3, wherein the latency period corresponds to the period from a time of a beginning of rendering to a time of display of the image of the at least one display object in the smartglasses.

8. The method according to claim 1, wherein each of the at least one piece of object information corresponds to a vector model of a corresponding displayable display object.

9. The method according to claim 2, wherein each of the at least one piece of object information corresponds to a vector model of a corresponding displayable display object.

10. The method according to claim 3, wherein each of the at least one piece of object information corresponds to a vector model of a corresponding displayable display object.

11. The method according to claim 1, wherein the warping process in the smartglasses and the display of the at least one warped display object are performed at a higher frequency than the rendering.

12. The method according to claim 2, wherein the warping process in the smartglasses and the display of the at least one warped display object are performed at a higher frequency than the rendering.

13. The method according to claim 3, wherein the warping process in the smartglasses and the display of the at least one warped display object are performed at a higher frequency than the rendering.

14. The method according to claim 1, wherein, in addition to the at least one display object, at least one piece of object information is also transferred by the central processing unit for rendering in the smartglasses.

15. The method according to claim 2, wherein, in addition to the at least one display object, at least one piece of object information is also transferred by the central processing unit for rendering in the smartglasses.

16. The method according to claim 3, wherein, in addition to the at least one display object, at least one piece of object information is also transferred by the central processing unit for rendering in the smartglasses.

17. A display system comprising:
a central processing unit in a vehicle; and
smartglasses,
wherein the central processing unit includes:
a communication unit; and
a control unit configured to:
provide at least one piece of object information;
provide a surroundings-based glasses pose with respect to a surroundings coordinate system and/or a vehicle-based glasses pose with respect to a vehicle coordinate system;
render at least one display object for a respective at least one piece of object information for contact-analogous vehicle-fixed or world-fixed display according to the surroundings-based or the vehicle-based glasses pose;
transfer the at least one display object to the smartglasses via the communication connection;
wherein the smartglasses are configured to:
acquire glasses motion information via a glasses inertial sensor system and/or obtaining vehicle motion information,
perform a warping process for the at least one display object based on a change in the world-fixed glasses pose during a latency period and/or based on a change in the world-fixed vehicle pose during the latency period,
display the at least one warped display object.

18. A central processing unit for a display system including smartglasses, the central processing unit comprising:
a communication unit;
a control unit configured to:
provide at least one piece of object information;
provide a surroundings-based glasses pose with respect to a surroundings coordinate system and/or a vehicle-based glasses pose with respect to a vehicle coordinate system;
render at least one display object for a respective at least one piece of object information for contact-analogous vehicle-fixed or world-fixed display according to the surroundings-based or the vehicle-based glasses pose;
transfer the at least one display object to the smartglasses externally via the communication connection.
